(19) United States
(12) Patent Application Publication
(10) Pub. No.: US 2007/0092600 A1
(43) Pub. Date: Apr. 26, 2007

(54) Film sweetening composition

(76) Inventors: Toshiharu Miyai, Okayama (JP); Yasuhiro Toshimori, Okayama (JP); Masanori Akiba, Okayama (JP)

Correspondence Address: BROWDY AND NEIMARK, P.L.L.C.;624 NINTH STREET, NW, SUITE 300, WASHINGTON, DC, 20001-5303, US

(21) Appl. No.: 10/560,931

(22) PCT Filed: Jun. 14, 2004
(86) PCT No.: PCT/JP04/08317

§ 371 Date: Dec. 15, 2005

(30) Foreign Application Priority Data
Jun. 17, 2003 (JP) 172572/2003

(51) Int. Cl. A23G 4/00

(52) U.S. Cl. 426/3

(57) ABSTRACT

The present invention has an object to provide a film-shaped sweet composition comprising sucralose as a sweetener with high sweetness, and attains the object by establishing a film-shaped sweet composition comprising sucralose and one or more polysaccharides selected from the group consisting of homo- and hetero-saccharides.

### TECHNICAL FIELD

The present invention relates to a novel film-shaped sweet composition, more particularly, to a film-shaped sweet composition comprising sucralose as a sweetener with high sweetness.

### BACKGROUND ART

Sucralose, which has an about 600-fold sweetening power of sucrose and is produced from sucrose as a starting material, is a highly-safe and non-caloric sweetener with high sweetness. Since sucralose has advantageous properties such as high sweetness, high solubility in various solvents including water and alcohols, and anti-cariogenicity, it has been rapidly, extensively used in various fields of food products, cosmetics, and pharmaceuticals (for example, see Japanese Patent Laid-Open Publication Nos. 85055/89, 258714/90, and 2002-136270).

Conventional sucralose, however, has been provided in a powder form so that it has one demerit that, when users use it to sweeten their preferences and beverages such as black tea and coffee, they tend to use it in an amount of over sufficient amount and to over sweeten them because conventional sucralose apparently could hardly be distinguishable from sucrose and because it has a high sweetness. Further, sucralose in a powder form has another demerit that it is easily scattered because of its particle form. As another demerit, conventional sucralose could not be easily sprayed uniformly over the surface of food products and this easily results in imparting inhomogeneous sweetness to the food products. Sucralose has also the other demerit that it may cause browning under environmental conditions with a relatively high temperature and may result in quality deterioration, though it has substantially the same level of thermal stability as sucrose. As the change of recent life-style, there has been required an up-to-date-shaped sucralose that sloughs off conventional image of sucralose provided in a powder form.

### DISCLOSURE OF INVENTION

The present invention was made to overcome the demerits of the above prior art. The present invention aims to provide a film-shaped sweet composition, which is a sucralose product formed to be easily and handily used in a requisite amount to meet general users' desired use; has an up-to-date shape completely different from conventional sucralose in a powder form; has an advantageous water-solubility, spreadability, tensile strength, storage stability, and high sweetness; and in which sucralose is stably retained without browning even when placed under environmental conditions with a relatively high temperature.

The present inventors energetically studied to attain the above object. As a result, they found that a film-shaped sweet composition, which comprises sucralose and one or more polysaccharides selected from homo- and hetero-polysaccharides, attains the above object, and thus they accomplished this invention.

### BEST MODE FOR CARRYING OUT THE INVENTION

The film-shaped sweet composition according to the present invention is described hereinafter. The term “homopolysaccharides” as referred to as in the present invention means polysaccharides in general which are composed of a single-type of saccharide. Concrete examples of such are those consisted of D-glucose molecules as constituent saccharides; pullulan, elsinan, dextran, nigeran, cellulose, curdlan, carrageenan, sclerotan, isosclerotan, scleroglucan, schizophyllan, β-1,2-glucan, β-1,3-glucan, luteic acid, levan, phosphomannan, α-1,6-mannan, starch, and derivatives thereof. In the present invention, among the above homopolysaccharides, pullulan and elsinan, which are consisted of maltotriose units each composed of three glucose molecules, are preferably used. In particular, pullulan is most preferably used in the present invention because it has a satisfactory compatibility with sucralose and an advantageous solubility in various solvents such as water, as well as having thermal stability, light tolerance, storage stability, and non-cariogenicity. Examples of such pullulan include comercialized pullulan products and those which are obtainable by the methods disclosed in Japanese Patent Publication Nos. 36,360/76, 42,199/76, and 27,099/80, and Japanese Patent No. 3,232,488. Concrete examples of the method for producing pullulan include those which comprise the steps of culturing a pullulan-producing microorganism, for example, in a liquid culture medium containing one or more saccharides such as glucose, maltose, maltooligosaccharides, isomaltooligosaccharides, hydrolyzed starch syrup (corn syrup), sucrose, fructose, saccharified/inverted saccharides, isomerized sugars, and molasses; and collecting the pullulan produced in the culture medium. Examples of other methods for producing pullulan are those which comprise the steps of filtering a pullulan-containing-culture medium, obtained by culturing the above pullulan-producing microorganism in the above culture medium in such a manner of batchwise, semi-continuous, or continuous manner, to remove microorganisms; and if necessary the resulting filtrate is desalted, decolored, and concentrated into a pullulan product. In addition, it can be exemplified a method comprising a step of drying and pulverizing the above concentrate after optional purification; or the steps of desalting the resulting culture obtained in the above method, treating the desalted culture with alcohol sedimentation to precipitate pullulan, and drying the precipitated pullulan into pullulan products. The pullulan products thus obtained have a weight average molecular weight of at least about 50,000. Among these, those which have a weight average molecular weight of at least about 100,000, preferably, about 150,000 to 300,000 can be advantageously used. In the case of pullulan having a weight average molecular weight of less than 100,000, it is not suitable in terms of the moldability and strength of film-shaped sweet compositions obtained by using such pullulan products, while in the case of pullulan having a weight average molecular weight of over about 300,000, it is not suitable because of its poor processibility and solubility in solvents.

The “heteropolysaccharides” used in the present invention mean polysaccharides composed of at least two types of saccharides. Concrete examples of such are xanthan gum, succinoglucan, rhamnogalactan, emulsan, guar gum, locust bean gum, tragacanth gum, gam arabic, tamarind gum, polysaccharides derived from Arthrobacter viscosus (NRRL B-1973), Corynebacterium insidiosum, Aerobacter sp. (IFO 12367), Cryptococcus laurentii (NRRL Y-1401), or Bacillus polymyxa, and derivatives thereof.

In the present invention, one or more of the above homo- and hetero-polysaccharides can be used in an appropriate combination.

One or more of sucralose and edible derivatives thereof can be used in an appropriate combination as the sucralose used in the present invention. Throughout the specification, these sucralose and edible derivatives thereof are simply called generically as “sucralose”, unless specified otherwise.

The ratios of the homopolysaccharides, heteropolysaccharides, and sucralose incorporated in the film-shaped sweet composition of the present invention are as follows: To one part by weight of sucralose one or more of the homo- and hetero-polysaccharides are used in a total amount of, usually, 0.5 to 1,000 parts by weight, preferably, 1 to 100 parts by weight, and more preferably, 5 to 50 parts by weight. In case that the above total amount is below the lower limit (0.5 part by weight), it is not desirable because it may cause an unfavorable result in the film formability or the strength of the film-shaped sweet composition of the present invention. While, in case that the above total amount is over the upper limit (1,000 parts by weight), it is not desirable because it may deteriorate the mouth feel or lower the solubility in water or hydrophilic solvents such as alcohols. However, considering the use of the film-shaped sweet composition, when the composition should only fulfil either of the film strength, mouth feel, or solubility in water or hydrophilic solvents such as alcohols, it is feasible to employ the ratios outside the above lower or upper limit. Examples of the above solvents include one or more of various solvents such as water and alcohols, which can dissolve the components of the film-shaped sweet composition, can be used in an appropriate combination.

The film-shaped sweet composition of the present invention can be arbitrarily formulated with one or more of the following other ingredients in an appropriate combination as long as they do not apart from the scope of the object of the present invention: Release agents, humectants, emulsifiers, colors, seasonings, preservatives, excipients, fillers, stabilizers, dispersants (or solvents) for polysaccharides, vitamins (for example, vitamin C, L-ascorbic acid-2-O-α-glucoside, hesperidin, α-glucosyl hesperidin, α-glycosyl hesperidin, rutin, α-glucosyl rutin, α-glycosyl rutin, naringin, α-glucosyl naringin, α-glycosyl naringin, quercetin, α-glucosyl quercetin, α-glycosyl quercetin); mono-, di-, tri- and more oligosaccharides and sugar alcohols thereof such as glucose, lactose, fructose, sucrose, lactosucrose, maltose, α,α-trehalose (simply called “trehalose”, hereinafter), maltotriose, maltotetraose, non-reducing tri- or more saccharides having a trehalose structure intramolecularly, raffinose, sorbitol, inositol, maltitol, maltotriitol, and maltotetraitol; cyclodextrins; cyclic tetrasaccharide having the structure of cyclo{→6)-α-D-glucopyranosyl-(1→3)-α-D-glucopyranosyl-(1→6)-α-D-glucopyranosyl-(1→3)-α-D-glucopyranosyl-(1}; cyclic tetrasaccharide having the structure of cyclo{→6)-α-D-glucopyranosyl-(1→4)-α-D-glucopyranosyl-(1→6)-α-D-glucopyranosyl-(1→4)-α-D-glucopyranosyl-(1→}; natural or synthetic sweeteners with high sweetness other than sucralose, such as acesulfam K, aspartame, alitame, cyclamate, neohesperidine dihydrochalcone, rebaudioside, stevioside, glycosyl stevioside, erythritol, xylitol, glycyrrhizin, licorice extract, stevia extract, enzyme-treated stevia, tenryocha extract, monellin (an extract of Discorephylum cumminsii), Momordica grosvenori extract, thaumatin, saccharin, and sodium saccharin; natural or synthetic flavors such as of an almond, Irish, apple, orange, lemon, kiwifruit (Actinidia chinensis), strawberry, cherry, banana, papaya, mango, pineapple, passionfruit, peach, plum, pumpkin, blueberry, raspberry, hazel nut, macadamia nut, chestnut, mint, lavender, rose, citronella, wood sandal, patchouli (Pogostemon patchouli), geranium, anise seed, jasmine, oakmoss (Evernia prunastri), cedar wood, lime, vanilla, Chai tea, chocolate, tiramisu, honey, caramel, pumpkin pie, guava, guarana, mugwort, coriander, coffee, cocoa, black tea, green tea, coconut, cinnamon, and ginger.

Among the above saccharides, maltitol, trehalose, and non-reducing tri- or more saccharides having a trehalose structure intramolecularly can be preferably used because of their high compatibility with sucralose. In the case of using water and hydrophilic solvents such as alcohols including ethanol as the above dispersants for polysaccharides, they can effectively improve the piercing strength and the tensile strength of the film-shaped sweet composition of the present invention. The effect of the above dispersants for polysaccharides is particularly remarkable when pullulan and one or more other polysaccharides selected from carrageenan, xanthan gum, and locust bean gum are used in combination as polysaccharides.

Although the percentage of the above-mentioned other ingredients is not specifically restricted, it is usually an amount of 0.001 to 90%, preferably, 0.01 to 80%, and more preferably, 0.1 to 80% to the total weight of the film-shaped sweet composition of the present invention.

The thickness of the film-shaped sweet composition of the present invention is not specifically restricted, however, it is usually at least 1 μm, preferably, 20 to 1,000 μm, and more preferably, 30 to 100 μm. The thickness of the film-shaped sweet composition of the present invention can be made to give a uniform thickness or can be changed partially or locally. The film-shaped sweet composition of the present invention can be arbitrarily formed in such a manner of allowing at least two types of film-shaped sweet compositions, whose components and/or thickness are the same or different, to be layered into a multi-layered-film-shaped sweet composition. In the case of forming into such a multi-layered-film-shaped-sweet composition, the whole thickness of the composition can be usually made in the range of 2 to 1,000 μm.

The term “film-shaped” as referred to as in the present invention means those which have a thickness within the above range in general, and includes all those which have a film or sheet form with the above-identified thickness, unless specified otherwise.

The film-shaped sweet composition of the present invention can be used independently of its size, and the size can be appropriately set depending on the capability and performance of film-shaping machines used to prepare the sweet composition, the handleability and processibility of the composition, and the needs of users. For example, the film-shaped sweet composition of the present invention can be processed and shaped into portion-type sweeteners in a relatively-small shape and size; square or rectangular films/sheets with a side length of 1 to 5 cm, circular or oval films/sheets with a diameter of 1 to 5 cm, and other films/sheets with different shapes and sizes.

As the characteristic features of the film-shaped sweet composition of the present invention, it can be made into a transparent or semitransparent product or can be colored partially or wholly by incorporating an adequate amount of one or more natural or synthetic food colors into the composition in the form of a film/sheet, or providing figures, letters, symbols, patterns, etc., on the film/sheet by conventional methods.

Varying depending on the composition, the film-shaped sweet composition of the present invention is the one which dissolves in 1 L of 20° C. water in an amount of 0.1 g within 100 seconds, preferably, within 70 seconds, and more preferably, within 30 seconds, when soaked in the water and then macroscopically observed while allowing to stand, in accordance with the method disclosed in “JIS Z 1707:1997” of Japanese Industrial Standards. The water solubility of the film-shaped sweet composition of the present invention can be arbitrarily controlled by the type and ratio of homo- and/or hetero-polysaccharides to sucralose. The above water solubility usually changes depending on the ratio of homo- and/or hetero-polysaccharides to sucralose rather than the type of homo- and/or hetero-polysaccharides; there is a tendency that the higher the ratio of homo- and/or hetero-polysaccharides the lower the water solubility becomes, while the lower the ratio of homo- and/or hetero-polysaccharides the higher the water solubility becomes.

Regarding the property of the film-shaped sweet composition of the present invention, it has the advantageous merit that the sucralose in the composition is stably retained compared with sucralose alone even when transported, stored, processed, or cooked under a relatively high temperature condition because the sucralose in the composition has been homogeneously mixed with homo- and/or hetero-polysaccharides and being interrupted or inhibited from contacting with oxygen in the air. As regards the other property of the film-shaped sweet composition, the strength of the composition can be modified by controlling the type and composition ratio of homo- and/or hetero-polysaccharides to sucralose, and water content of the composition. Concretely, the strength of the film-shaped sweet composition is changed depending on the type of homo- and/or hetero-polysaccharides used in combination with sucralose, and it can be increased or decreased in direct proportion to the increase or decrease of the ratio of homo- and/or hetero-polysaccharides against sucralose. The film-shaped sweet composition of the present invention preferably has a tensile strength of at least 450 gf, preferably, at least 1,000 gf, and more preferably, 1,000 to 10,000 gf when determined according to the method in “JIS Z 1707” of Japanese Industrial Standards under the conditions of a temperature of 20° C., relative humidity of 50%, tensile speed of 50 mm/min, and using a test sample 15 mm wide. The film-shaped sweet composition of the present invention has also a relatively high piercing strength as a feature; it has a piercing strength of at least 10 gf, preferably, at least 20 gf, and more preferably, 50 to 5,000 gf when determined according to the method in “JIS Z 1707” of Japanese Industrial Standards under the conditions of a temperature of 20° C., relative humidity of 50%, and piercing speed of 50 mm/min by using a needle having a diameter of 1.0 mm and a semicircular-shaped edge with a diameter of 1 mm. In the following explanations, the tensile strength and the piercing strength of the film-shaped sweet composition of the present invention are the data determined under the above conditions. Among the film-shaped sweet compositions according to the present invention, those, which have a ratio of the tensile strength (X) against the piercing strength (Y) (=X/Y) being usually in the range of 1 to 50, preferably, 10 to 40, tend to be advantageous in terms of strength, handleability, and processibility.

The method for producing the film-shaped sweet product of the present invention should not be limited to the following Examples 1 to 6 and it should include methods for shaping films used to prepare conventional film-shaped compositions known before the filing of the present application.

The film-shaped sweet composition of the present invention thus obtained is used by adding or incorporating in an adequate amount to or in food products, health foods, therapeutic foods, cosmetics, pharmaceuticals, agricultural products, chemicals, feeds for livestock, bait for aquarium fish and cultivation fish, bait for fishing, pet foods, etc., to be sweetened. In the case of using the film-shaped sweet composition of the present invention in such a manner of placing on, attaching to, or adhering to the surface of the above-identified products, or rounding such products, it can homogeneously and easily sweeten the surface of such products. Depending on use, the film-shaped sweet composition of the present invention can be allowed to dissolve in an appropriate solvent or disperse in an appropriate carrier to homogeneity, and then the resultant can be allowed to add or incorporate to or in the above-identified products by using conventional mixing, kneading, soaking, applying, spraying, adhering, spreading, etc. In the case of packing or covering products by using the film-shaped sweet composition intact or after dissolved in an appropriate solvent, it has the merit that it imparts an adequate gloss and a gas-barrier property to the products and retains or even improves the quality of the above-identified products.

The following explain a panel test on the mouth feel of the film-shaped sweet composition of the present invention and a stability test on sucralose in the sweet composition.

Experiment 1: Panel test There were provided the film-shaped sweet composition of the present invention, obtained in the later described Example 1, and other film-shaped sweet compositions with any of aspartame, stevioside, and saccharin (called “Example for Reference 1”, “Example for Reference 2”, and “Example for Reference 3”, respectively), having a thickness of about 40 μm, a width of about 100 cm, a length of 10 m, a water content of about 9% (w/w), and a weight of about 0.6 g/100 cm², which were similarly prepared as in Example 1 except for replacing sucralose with aspartame, stevioside, or saccharin as another sweetener with high sweetness. These sweet compositions were respectively cut in a size one centimeter long and two centimeters broad and subjected as test samples to a panel test with 20 panels. The panels were asked to taste the above sweet compositions without noticing what types they were and allowed to select the one which they preferred best, based on their mouth feel, sweetening power, and after taste as film-shaped sweeteners, followed by summing up the number of panels for each item for testing. The results are in Table 1.

TABLE 1

| | The | | | |
|---|---|---|---|---|
| | present | Example for | Example for | Example for |
| | invention | Reference 1 | Reference 2 | Reference 3 |
| Mouth feel | 8 | 5 | 4 | 3 |
| Sweetening | 15 | 0 | 0 | 5 |
| power | | | | |
| After taste | 8 | 6 | 3 | 3 |
| Total evaluation | 31 | 11 | 7 | 11 |
| (Total number of | | | | |
| panels) | | | | |

From the results in Table 1, the film-shaped sweet composition of the present invention had superior properties in every item for testing to those of Example for Reference 1 to 3. These results show a usefulness as a sweetener of the film-shaped sweet composition containing sucralose according to the present invention.

Experiment 2: Stability test on sucralose in film-shaped sweet composition

To examine the stability of sucralose in the film-shaped sweet composition of the present invention, 5.0 g of a film-shaped sweet composition of the present invention, obtained by the method in the later described Example 1, with a sucralose content of 10%, on a dry solid basis, and as a control 0.51 g of a powdered sucralose specimen with a purity of 98.0% commercialized by Wako Pure Chemicals, Tokyo, Japan, were respectively placed in a glass petri dish, kept at 100° C. for 30 min in a thermostat incubator, and then macroscopically observed. While the specimens after the heat treatment were respectively dissolved in 100 ml of refined water and macroscopically observed for color tint. Using a 1-cm light-pass-cell, each aqueous solution was measured for absorbance at wavelengths of 420 nm and 720 nm, which correspond to the absorbances of a brown-colored substance formed by the decomposition of sucralose, and determined the difference between the absorbances at each of the above wavelengths before and after the heat treatment. Separately, the absorbances at the above absorption wavelengths for the film-shaped sweet composition and the powdered sucralose specimen before the above heat treatment were respectively determined in such a manner of dissolving either 0.51 g of the powdered sucralose specimen before the heat treatment or 5.0 g of the film-shaped sweet composition of the present invention in 100 ml of refined water, and measuring the absorbances at the absorption wavelengths for each of the resulting solutions.

As a result, the powdered sucralose specimen, as a control, highly browned after the heat treatment, and the resulting aqueous solution was a brown-colored one. Before and after the heat treatment, the aqueous solution of the sucralose specimen was increased in absorbances at wavelengths of 420 nm and 720 nm by 0.65 and 0.37, respectively.

While in the case of the film-shaped sweet composition, no substantial difference was found when observed macroscopically and measured for absorbances at the absorption wavelengths of 420 nm and 720 nm before and after the heat treatment.

These experimental results revealed that the sucralose, contained in the film-shaped sweet composition of the present invention, was retained in quite a stable state against heat; it was revealed that the film-shaped sweet composition of the present invention has a significantly superior stability during storage and processing to conventional powdered sucralose. This result was far beyond the present inventors' expectation.

The preparation method, property, and use of the film-shaped sweet composition according to the present invention are described in detail with reference to the following Examples hereinafter:

### EXAMPLE 1

### Sweet Composition

Under a stirring condition at ambient temperature, to 220 parts by weight of deionized water was added 0.614 part by weight of “AVICEL RC-N30^{th}”, a product name of crystalline cellulose produced by Asahi Chemical Industry Co., Ltd., Tokyo, Japan, followed by mixing. To the mixture was gradually added 1.54 parts by weight of carrageenan and 0.31 part by weight of xanthan gum, both of which had been dissolved in 2.15 parts by weight of 85% aqueous ethanol solution as a solvent for polysaccharides, followed by addition of 67.5 parts by weight of “PI 20”, a product name of pullulan with a weight average molecular weight of about 200,000 commercialized by Hayashibara Shoji Inc., Okayama, Japan, and then successive stirring, heating to 94° C. over 2.5 hours, and adjustment to a temperature of 80 to 75° C. To the mixture thus obtained were added 8.60 parts by weight of sucralose which had been dissolved in 13 parts by weight of deionized water, 1.84 parts by weight of a caramel pigment, 1.84 parts by weight of food glycerin as a humectant, 1.84 parts by weight of sucrose ester as an emulsifier, and deionized water in an amount sufficient to make the total amount of the final mixture to 246 parts by weight. The resulting mixture was stirred at 75 to 80° C. for about 30 min to obtain an aqueous solution containing sucralose. After deaerating by incubation at 65° C., the aqueous solution was poured over a belt conveyor and dried at 80 to 85° C. into a film-shaped sweet composition, followed by winding it up around a roll at a winding rate of 8 m/min to obtain a film-shaped sweet composition with about 40 μm in thickness, about 100 cm in width, 1,200 m in length, about 9% (w/w) of water, and about 0.6 g/100 cm² by weight. 0.1 g of the film-shaped sweet composition was soaked in one litter of 20° C. water placed in a beaker, and then macroscopically observed while allowing to stand, resulting in a dissolution within about 15 seconds. The film-shaped sweet composition had a tensile strength of about 1,800 gf and a piercing strength of about 60 gf.

In use, the product is cut in an appropriate size to meet its use or used in such a manner of cutting the product in a desired size, casing the resulting sheets in an appropriate container by 1 to 1,000 sheets per container, and taking the desired numbers of sheets out from the container prior to use. The product is a pale-brown-semitransparent-film-shaped-sweet composition which can be arbitrarily used intact in food products, health foods, therapeutic foods, cosmetics, pharmaceuticals, agricultural products, chemicals, feeds for livestock, bait for aquarium fish and cultivation fish, bait for fishing, pet foods, etc., to be sweetened; or used by dissolving in an appropriate solvent. The product instantly melts when taken in one's mouth and it can be advantageously used as a high quality film-shaped sweetener which exhibits the high sweetness inherent to sucralose. The product is a stable composition free of color changing, deformation, and melting even when allowed to stand at ambient temperature for six to twelve months.

### EXAMPLE 2

### Sweet Composition

Similarly as in Example 1, except for using as a polysaccharide 70 parts by weight of “PI 20”, a product name of pullulan with a weight average molecular weight of about 200,000 commercialized by Hayashibara Shoji Inc., Okayama, Japan, a film-shaped sweet composition with about 50 μm in thickness, about 120 cm in width, 1,000 m in length, about 8% (w/w) of water, and about 0.7 g/100 cm² by weight. 0.1 g of the film-shaped sweet composition was soaked in one litter of 20° C. water placed in a beaker, and then macroscopically observed while allowing to stand, resulting in a dissolution within about 20 seconds. The film-shaped sweet composition had a tensile strength of about 1,000 gf and a piercing strength of about 35 gf.

In use, the product is cut in an appropriate size to meet its use or used in such a manner of cutting the product in a desired size, casing the resulting sheets in an appropriate container by 1 to 1,000 sheets per container, and taking the desired numbers of sheets out from the container prior to use. The product, a colorless-semitransparent-film-shaped-sweet composition, can be arbitrarily used intact in food products, health foods, therapeutic foods, cosmetics, pharmaceuticals, agricultural products, chemicals, feeds for livestock, bait for aquarium fish and cultivation fish, bait for fishing, pet foods, etc., to be sweetened; or used by dissolving in an appropriate solvent. The product instantly melts when taken in one's mouth and it can be advantageously used as a high quality film-shaped sweetener which exhibits the high sweetness inherent to sucralose. The product is a stable composition free of color changing, deformation, and melting even when allowed to stand at ambient temperature for three to six months.

### EXAMPLE 3

### Sweet Composition

Similarly as in Example 1, except for using 1.45 parts by weight of glycerin, 0.01 part by weight of maltitol, 11.6 parts by weight of sucralose, and 2.32 parts by weight of sucrose ester in the method of Example 1, a film-shaped sweet composition with about 100 μm in thickness, about 100 cm in width, 1,000 m in length, about 8.5% (w/w) of water, and about 1.2 g/100 cm² by weight. 0.1 g of the film-shaped sweet composition was soaked in one litter of 20° C. water placed in a beaker, and then macroscopically observed while allowing to stand, resulting in a dissolution within about 40 seconds. The sweet composition had a tensile strength of about 3,200 gf and a piercing strength of about 150 gf.

In use, the product is cut in an appropriate size to meet its use or used in such a manner of cutting the product in a desired size, casing the resulting sheets in an appropriate container by 1 to 1,000 sheets per container, and taking the desired numbers of sheets out from the container prior to use. The product, a pale-brown-semitransparent-film-shaped-sweet composition, can be arbitrarily used intact in food products, health foods, therapeutic foods, cosmetics, pharmaceuticals, agricultural products, chemicals, feeds for livestock, bait for aquarium fish and cultivation fish, bait for fishing, pet foods, etc., to be sweetened; or used by dissolving in an appropriate solvent. The product instantly melts when taken in one's mouth and it can be advantageously used as a high quality film-shaped sweetener which exhibits the high sweetness inherent to sucralose. The product is a stable composition free of color changing, deformation, and melting even when allowed to stand at ambient temperature for three to six months.

### EXAMPLE 4

### Sweet Composition

Twenty-two parts by weight of “PI 20”, a product name of pullulan with a weight average molecular weight of about 200,000 commercialized by Hayashibara Shoji Inc., Okayama, Japan, 0.50 part by weight of carrageenan, 0.10 part by weight of xanthan gum, 0.70 part by weight of 85% aqueous ethanol solution for a solvent for polysaccharides, 0.01 part by weight of α,α-trehalose, 0.50 part by weight of glycerin, 4.0 parts by weight of sucralose, 0.5 part by weight of a caramel pigment, 0.80 part by weight of sucrose ester as an emulsifier, and 84.0 parts by weight of refined water were dissolved by stirring at 90° C. for three hours. The solution was poured to homogeneity over a stainless-steel plate, 2×10 m, dried at 60° C. for four hours to obtain a film-shaped sweet composition with about 200 μm in thickness, about 200 cm in width, 10 m in length, about 8% (w/w) of water, and about 2.2 g/100 cm² by weight. 0.1 g of the film-shaped sweet composition was soaked in one litter of 20° C. water placed in a beaker, and then macroscopically observed while allowing to stand, resulting in a dissolution within about 40 seconds. The film-shaped sweet composition had a tensile strength of about 3,000 gf and a piercing strength of about 100 gf.

In use, the product is cut in an appropriate size to meet its use or used in such a manner of cutting the product in a desired size, casing the resulting sheets in an appropriate container by 1 to 1,000 sheets per container, and taking the desired numbers of sheets out from the container prior to use. The product, a pale-brown-semitransparent-film-shaped-sweet composition, can be arbitrarily used intact in food products, health foods, therapeutic foods, cosmetics, pharmaceuticals, agricultural products, chemicals, feeds for livestock, bait for aquarium fish and cultivation fish, bait for fishing, pet foods, etc., to be sweetened; or used by dissolving in an appropriate solvent. The product instantly melts when taken in one's mouth and it can be advantageously used as a high quality film-shaped sweetener which exhibits the high sweetness inherent to sucralose. The product is a stable composition free of color changing, deformation, and melting even when allowed to stand at ambient temperature for three to six months.

### EXAMPLE 5

### Sweet Composition

The film-shaped sweet compositions, obtained in Examples 1 to 3, were respectively cut in a size of 50×50 cm, and the one obtained in Example 1 was multilayered with the ones obtained in Examples 2 and 3 in this order, and compression molded to obtain a three-layered-film-shaped-sweet composition with about 150 μm in thickness. Similarly as the film-shaped sweet compositions obtained in Examples 1 to 3, the product can be preferably used to sweeten various food products, cosmetics, and pharmaceuticals.

### EXAMPLE 6

### Sweet Composition

The aqueous sucralose solution obtained in Example 1 was placed in a stainless steel container, 100 cm long, 200 cm broad and 5 cm deep, and dried by heating at 68° C. overnight. The dried product was taken out from the container and homogeneously compressed by a roller to obtain a film-shaped sweet composition with about 500 μm in thickness. The product is cut in an appropriate size and used as a sweetener for cooking.

### EXAMPLE 7

### Sweet Composition

Twenty-two parts by weight of “PI 20”, a product name of pullulan with a weight average molecular weight of about 200,000 commercialized by Hayashibara Shoji Inc., Okayama, Japan, 0.70 part by weight of 85% aqueous ethanol solution for a solvent for polysaccharides, 0.02 part by weight of α,α-trehalose, 0.01 part by weight of maltose, 0.50 part by weight of glycerin, 4.0 parts by weight of sucralose, 2.0 parts by weight of aspartame, 0.7 part by weight of food yellow No.4, 0.5 part by weight of a vanilla flavor, 0.80 part by weight of sucrose ester as an emulsifier, and 84.0 parts by weight of refined water were mixed to dissolve at 90° C. for three hours. The resulting solution was poured to homogeneity over a stainless-steel plate, 2×10 m, dried at 60° C. for four hours to obtain a film-shaped sweet composition with about 150 μm in thickness, about 200 cm in width, 10 m in length, about 8% (w/w) of water, and about 2.2 g/100 cm² by weight. 0.1 g of the film-shaped sweet composition was soaked in one litter of 20° C. water placed in a beaker and then macroscopically observed while allowing to stand, resulting in a dissolution within about 40 seconds. The film-shaped sweet composition had a tensile strength of about 3,000 gf and a piercing strength of 100 gf.

In use, the product is cut in an appropriate size to meet its use or used in such a manner of cutting the product in a desired size, casing the resulting sheets in an appropriate container by 1 to 1,000 sheets per container, and taking the desired numbers of sheets out from the container prior to use. The product, a pale-brown-semitransparent-film-shaped-sweet composition, can be arbitrarily used intact in food products, health foods, therapeutic foods, cosmetics, pharmaceuticals, agricultural products, chemicals, feeds for livestock, bait for aquarium fish and cultivation fish, bait for fishing, pet foods, etc., to be sweetened; or used by dissolving in an appropriate solvent. The product instantly melts when taken in one's mouth and it can be advantageously used as a high quality film-shaped sweetener which exhibits the high sweetness inherent to sucralose. The product is a stable composition free of color changing, deformation, and melting even when allowed to stand at ambient temperature for three to six months.

### INDUSTRIAL APPLICABILITY

As described above, the present invention provides a sweet composition with high sweetness, containing sucralose and having a novel shape, which is completely different from conventional powdered sucralose sweet compositions. The film-shaped sweet composition can be arbitrarily made into colorless transparent or semitransparent ones, colored with appropriate food dyes, or processed and shaped into various forms and shapes. The film-shaped sweet composition has a satisfactory solubility and dispersibility in solvents such as water, advantageous strength and thermotolerance, and preferable handleability. In use, the film-shaped sweet composition of the present invention can be orally taken intact as a sweetener after cutting or previously having been cut into pieces in an appropriate amount, or preferably used in food products, health foods, therapeutic foods, cosmetics, pharmaceuticals, agricultural products, chemicals, feeds for livestock, bait for aquarium fish and cultivation fish, bait for fishing, pet foods, etc. The film-shaped sweet composition of the present invention is a low-caloric sweetener with high sweetness without fear of causing dental caries. Since the film-shaped sweet composition has an improved adhesion and adhesive property to high-moisture content products, it has the advantageous feature that it can homogeneously sweeten the surface of such products in a requisite minimum amount of sucralose by placing on, attaching to, adhering to, or covering over the surface of such products. The film-shaped sweet composition of the present invention has also a gas-barrier ability so that it advantageously, stably retain their shelf-life for a relatively long period of time when used to package or cover the surface of such products. Thus, the present invention would have a great influence on this art.

1. A film-shaped sweet composition, which comprises sucralose and one or more polysaccharides selected from the group consisting of homo- and hetero-polysaccharides.

2. The film-shaped sweet composition of claim 1, wherein said homopolysaccharides are those which are composed of repeating units of maltotriose.

3. The film-shaped sweet composition of claim 2, wherein said homopolysaccharides composed of repeating units of maltotriose are pullulan or elsinan.

4. The film-shaped sweet composition of claim 1, which comprises 0.5 to 1,000 parts by weight of said one or more polysaccharides selected from the group consisting of homo- and hetero-polysaccharides to one part by weight of said sucralose.

5. The film-shaped sweet composition of claim 1, which comprises, as polysaccharides, a combination of pullulan and one or more members selected from the group consisting of carrageenan, locust bean gum, and xanthan gum.

6. The film-shaped sweet composition of claim 1, which further contains one or more ingredients selected from the group consisting of release agents, humectants, emulsifiers, flavors, colors, seasonings, preservatives, excipients, fillers, stabilizers, dispersants for polysaccharides, vitamins, natural or synthetic sweeteners with high sweetness other than sucralose, non-reducing saccharides, sugar alcohols, cyclodextrins, and cyclic tetrasaccharide having the structure of cyclo{→6)-α-D-glucopyranosyl-(1→3)-α-D-glucopyranosyl-(1→6)-α-D-glucopyranosyl-(1→3)-α-D-glucopyranosyl-(1→).

7. The film-shaped sweet composition of claim 1, which dissolves in one liter of 20° C. water within 100 seconds when 0.1 g of which is soaked therein and then macroscopically observed while allowing to stand.

8. The film-shaped sweet composition of claim 1, which has a tensile strength of at least 450 gf when determined according to the method in “JIS Z 1707:1997” of Japanese Industrial Standards under the conditions of a temperature of 20° C., relative humidity of 50%, tensile speed of 50 mm/min, and using a test sample 15 mm wide.

9. The film-shaped sweet composition of claim 6, wherein said sweetener with high sweetness is one or more members selected from the group consisting of acesulfam K, aspartame, alitame, cyclamate, neohesperidine dihydrochalcone, rebaudioside, stevioside, glycosyl stevioside, erythritol, xylitol, glycyrrhizin, licorice extract, stevia extract, enzyme-treated stevia, tenryocha extract, monellin (an extract of Discorephylum cumminsii), Momordica grosvenori extract, thaumatin, saccharin, and sodium saccharin.

10. The film-shaped sweet composition of claim 6, wherein said flavor is one or more members selected from the group consisting of those of an almond, Irish, apple, orange, lemon, kiwifruit (Actinidia chinensis), strawberry, cherry, banana, papaya, mango, pineapple, passionfruit, peach, plum, pumpkin, blueberry, raspberry, hazel nut, macadamia nut, chestnut, mint, lavender, rose, citronella, wood sandal, patchouli (Pogostemon patchouli), geranium, anise seed, jasmine, oakmoss (Evernia prunastri), cedar wood, lime, vanilla, Chai tea, chocolate, tiramisu, honey, caramel, pumpkin pie, guava, guarana, mugwort, coriander, coffee, cocoa, black tea, green tea, coconut, cinnamon, and ginger.
